(19) United States
(12) Patent Application Publication
(10) Pub. No.: US 2023/0226676 A1
(43) Pub. Date: Jul. 20, 2023

(54) Fastener Driving Apparatus

(71) Applicant: Tricord Solutions, Inc., Brentwood, TN (US)

(72) Inventor: Christopher Pedicini, Brentwood, TN (US)

(21) Appl. No.: 18/083,381

(22) Filed: Dec. 16, 2022

Related U.S. Application Data
(60) Provisional application No. 63/291,118, filed on Dec. 17, 2021.

(51) Int. Cl. B25C 1/06

(52) U.S. Cl. CPC B25C 1/06

(57) ABSTRACT

A fastener driving apparatus comprises a linear motor, a power source, a control circuit, an energy storage means, a drive mechanism, a piston and an anvil. The motor and drive mechanism are operatively coupled to the energy storage device and/or the piston such that they may alternately actuate the piston and/or engage the energy storage device, and then refrain from acting on the piston and/or energy storage device so as to selectively store potential energy in the energy storage device during, and then to allow the piston to move and act on the anvil to cause the anvil to act on a fastener. In an embodiment, the linear motor comprises a magnetic housing and at least one magnet such that when a voltage is applied across the terminals of the motor, the motor is caused to move to one direction. Reversing the polarity of the applied voltage will move the motor to the opposite direction.

### CROSS REFERENCE TO RELATED APPLICATIONS

The present application is a non-provisional application of and claims priority under 35 U.S.C. § 119 on pending U.S. Provisional Patent Application Ser. No. 63/291,118, filed on Dec. 17, 2023, the disclosure of which is incorporated by reference.

### FIELD OF THE DISCLOSURE

The present disclosure relates to fastener driving apparatuses, and, more particularly, to such fastener or staple driving mechanisms that require operation as a hand tool.

### BACKGROUND

Electromechanical fastener driving apparatuses (also referred to herein as a “driver,” “gun” or “device”) known in the art often weigh generally less than 15 pounds and may be configured for an entirely portable operation. Contractors and homeowners commonly use power-assisted devices and means of driving fasteners into wood. These power-assisted means of driving fasteners can be either in the form of finishing fastener systems used in baseboards or crown molding in house and household projects, or in the form of common fastener systems that are used to make walls or hang sheathing onto same. These systems can be portable (i.e., not connected or tethered to an air compressor or wall outlet) or non-portable.

The most common fastener driving apparatus uses a source of compressed air to actuate a guide assembly to push a fastener into a substrate. For applications in which portability is not required, this is a very functional system and allows rapid delivery of fasteners for quick assembly. A disadvantage is that it does however require that the user purchase an air compressor and associated air-lines in order to use this system. A further disadvantage is the inconvenience of the device being tethered (through an air hose) to an air compressor.

To solve this problem, several types of portable fastener drivers operate off of fuel cells. Typically, these guns have a guide assembly in which a fuel is introduced along with oxygen from the air. The subsequent mixture is ignited with the resulting expansion of gases pushing the guide assembly and thus driving the fastener into the workpieces. This design is complicated and is far more expensive then a standard pneumatic fastener gun. Both electricity and fuel are required as the spark source derives its energy typically from batteries. The chambering of an explosive mixture of fuel, the use of consumable fuel cartridges, the loud report and the release of combustion products are all disadvantages of this solution. Systems such as these are already in existence and are sold commercially to contractors under the Paslode™ name.

Another commercially available solution is a fastener gun that uses electrical energy to drive a stapler or wire brad. Such units typically use a solenoid to drive the fastener (such as those commercially available under the Arrow™ name or those which use a ratcheting spring system such as the Ryobi™ electric stapler). These units are limited to short fasteners (typically 1″ or less), are subject to high reactionary forces on the user and are limited in their repetition rate. The high reactionary force is a consequence of the comparatively long time it takes to drive the fastener into the substrate. Additionally, because of the use of mechanical springs or solenoids, the ability to drive longer fasteners or larger fasteners is severely restricted, thus relegating these devices to a limited range of applications. A further disadvantage of the solenoid driven units is they often must be plugged into the wall in order to have enough voltage to create the force needed to drive even short fasteners.

A final commercially available solution is to use a flywheel mechanism and clutch the flywheel to an anvil that drives the fastener. Examples of such tools can be found under the Dewalt™ name. This tool is capable of driving the fasteners very quickly and in the longer sizes. The primary drawback to such a tool is the large weight and size as compared to the pneumatic counterpart. Additionally, the drive mechanism is very complicated, which gives a high retail cost in comparison to the pneumatic fastener gun.

Clearly based on the above efforts, a need exists to provide portable solution to driving fasteners which is unencumbered by fuel cells or air hoses. Additionally, the solution ought to provide a low reactionary feel, be able to drive full size fasteners and be simple, cost effective and robust in operation.

The prior art teaches several additional ways of driving a fastener or staple. The first technique is based on a multiple impact design. In this design, a motor or other power source is connected to an impact anvil through either a lost motion coupling or other device. This allows the power source to make multiple impacts on the fastener to drive it into the workpiece. The disadvantages in this design include increased operator fatigue since the actuation technique is a series of blows rather than a single drive motion. A further disadvantage is that this technique requires the use of an energy absorbing mechanism once the fastener is seated. This is needed to prevent the anvil from causing excessive damage to the substrate as it seats the fastener. Additionally, the multiple impact designs are not very efficient because of the constant motion reversal and the limited operator production speed.

A second design that is taught in U.S. Pat. Nos. 3,589,988, 5,503,319, and 3,172,121 includes the use of potential energy storage mechanisms (in the form of a mechanical spring). In these designs, the spring is cocked (or activated) through an electric motor. Once the spring is sufficiently compressed, the energy is released from the spring into the anvil (or fastener driving piece), thus pushing the fastener into the substrate. Several drawbacks exist to this design. These include the need for a complex system of compressing and controlling the spring, and in order to store sufficient energy, the spring must be very heavy and bulky. Additionally, the spring suffers from fatigue, which gives the tool a very short life. Finally, metal springs must move a significant amount of mass in order to decompress, and the result is that these low-speed fastener drivers result in a high reactionary force on the user.

To improve upon this design, an air spring has been used to replace the mechanical spring. U.S. Pat. No. 4,215,808 teaches of compressing air within a guide assembly and then releasing the compressed air by use of a gear drive. This patent overcomes some of the problems associated with the mechanical spring driven fasteners described above, but is subject to other limitations. One particular troublesome issue with this design is the safety hazard in the event that the anvil jams on the downward stroke. If the fastener jams or buckles within the feeder and the operator tries to clear the jam, he is subject to the full force of the anvil, since the anvil is predisposed to the down position in all of these types of devices. A further disadvantage presented is that the fastener must be fed once the anvil clears the fastener on the backward stroke. The amount of time to feed the fastener is limited and can result in jams and poor operation, especially with longer fasteners. A further disadvantage to the air spring results from the need to have the ratcheting mechanism as part of the anvil drive. This mechanism adds weight and causes significant problems in controlling the fastener drive since the weight must be stopped at the end of the stroke. This added mass slows the fastener drive stroke and increases the reactionary force on the operator. Additionally, because significant kinetic energy is contained within the air spring and piston assembly the unit suffers from poor efficiency. This design is further subject to a complicated drive system for coupling and uncoupling the air spring and ratchet from the drive train which increases the production cost and reduces the system reliability.

U.S. Pat. No. 5,720,423 again teaches of an air spring that is compressed and then released to drive the fastener. The drive or compression mechanism used in this device is limited in stroke and thus is limited in the amount of energy which can be stored into the air stream. In order to provide sufficient energy in the air stream to achieve good performance, this patent teaches use of a gas supply which preloads the guide assembly at a pressure higher than atmospheric pressure. Furthermore, the compression mechanism is bulky and complicated. In addition, the timing of the motor is complicated by the small amount of time between the release of the piston and anvil assembly from the drive mechanism and its subsequent re-engagement. Additionally, U.S. Pat. No. 5,720,423 teaches that the anvil begins in the retracted position, which further complicates and increases the size of the drive mechanism. Furthermore, because of the method of activation, these types of mechanisms as described in U.S. Pat. Nos. 5,720,423 and 4,215,808 must compress the air to full energy and then release off the tip of the gear while under full load. This method of compression and release causes severe mechanism wear. As will be discussed below, the present disclosure overcomes these and other limitations in the prior art use of air springs.

A third means for driving a fastener that is taught includes the use of flywheels as energy storage means. The flywheels are used to clutch a hammering anvil that impacts the fastener. This design is described in detail in U.S. Pat. Nos. 4,042,036, 5,511,715, and 5,320,270. One major drawback to this design is the problem of coupling the flywheel to the driving anvil. This prior art teaches the use of a friction clutching mechanism that is both complicated, heavy and subject to wear. Further limiting this approach is the difficulty in controlling the energy in the fastener system. The mechanism requires enough energy to drive the fastener, but retains significant energy in the flywheel after the drive is complete. This further increases the design complexity and size of such prior art devices.

A fourth means for driving a fastener is taught in the present inventors' U.S. Pat. No. 8,079,504, which uses a compression on demand system with a magnetic detent. This system overcomes many of the advantages of the previous systems but still has its own set of disadvantages which include the need to retain a very high pressure for a short period of time. This pressure and subsequent force necessitate the use of high strength components and more expensive batteries and motors.

A fifth means is taught in pending U.S. Pat. No. 8,733,610, which uses a vacuum to drive a fastener drive assembly. This clearly has its own advantages over the previous systems but has its own set of disadvantages, including the need to retain a seal against air pressure. This sealing requirement necessitates the use of more accurate cylinders and pistons, thus contributing to the manufacturing cost.

All of the currently available devices suffer from one or more the following disadvantages:
Complex, expensive and unreliable designs. Fuel powered mechanisms such as Paslode™ achieve portability but require consumable fuels and are expensive. Rotating flywheel designs such as Dewalt™ have complicated coupling or clutching mechanisms based on frictional means. This adds to their expense.
Poor ergonomics. The fuel powered mechanisms have loud combustion reports and combustion fumes. The multiple impact devices are fatiguing and are noisy. Non-portability. Traditional fastener guns are tethered to a fixed compressor and thus must maintain a separate supply line.
High reaction force and short life. Mechanical spring driven mechanisms have high tool reaction forces because of their long fastener drive times. Additionally, the springs are not rated for these types of duty cycles leading to premature failure. Furthermore, consumers are unhappy with their inability seat longer fasteners or work with denser wood species.
Safety issues. The prior art “air spring” and heavy spring driven designs suffer from safety issues for longer fasteners since the predisposition of the anvil is towards the substrate. During jam clearing, this can cause the anvil to strike the operators hand.
The return mechanisms in most of these devices involve taking some of the drive energy. Either there is a bungee or spring return of the driving anvil assembly or there is a vacuum or air pressure spring formed during the movement of the anvil. All of these mechanisms take energy away from the drive stroke and decrease efficiency.

In light of these various disadvantages, there exists the need for a fastener driving apparatus that overcomes these various disadvantages of the prior art, while still retaining the benefits of the prior art.

### SUMMARY OF THE DISCLOSURE

In accordance with the present disclosure, a fastener driving apparatus is described which derives its power from an electrical source, preferably rechargeable batteries, and uses a motor (such as a linear motor or coil motor) to actuate an energy storage device or means such as a piston compressing air and/or gas or mechanical spring. After sufficient energy storage, the energy is released to accelerate an anvil and/or anvil assembly. The gas spring(s) of the present disclosure may contain air, for example, or, in another preferred embodiment, nitrogen. In an embodiment, the piston is connected to the anvil. The linear motor causes the piston to move to compress air, and/or compressing and energising the spring(s). Once the piston or spring(s) is/are energized (i.e., have accumulated potential energy), the motor can disengage from the piston or spring(s) to allow the piston to accelerate and actuate the anvil, or the spring(s) to accelerate the piston land anvil), to drive a fastener and/or impact a target.

The fastener driving cycle of the apparatus disclosed herein may start with an electrical signal, after which a circuit connects a linear motor to the electrical power source. The linear motor is coupled to a piston, for example, by way of a magnet that is disposed in the piston, in an operational cycle of the drive mechanism, the mechanism alternatively (1) actuates a gas spring piston (2) releases the piston to seat a fastener. For example, during a portion of its cycle, the linear motor may move the piston to increase potential energy stored within a spring or gas spring. In the next step of the cycle, the mechanism releases to allow the accumulated potential energy within the spring or gas spring to act on an anvil assembly to move and drive a fastener. In an embodiment, at least one bumper is disposed within the apparatus to reduce the wear on the piston and anvil assembly.

In an embodiment, a sensor and a control circuit are provided for determining at least one position of the gas spring, drive mechanism, piston, anvil and/or anvil assembly. The sensor may provide for enabling the proper timing for stopping the operational cycle of the apparatus. Further, this information can be used to detect a jam condition for proper recovery.

Accordingly, and in addition to the objects and advantages of the portable electric fastener gun as described above, several objects and advantages of the present disclosure are:
To provide a simple design for driving fasteners that has a significantly lower production cost than currently available nail guns and that is portable and does not require an air compressor.
To provide a fastener driving device that mimics the pneumatic fastener performance without a tethered air compressor.
To provide an electrical driven high power fastening device that has very little wear.
To provide a more energy efficient mechanism for driving nails than is presently achievable with a compressed air design.

These together with other aspects of the present disclosure, along with the various features of novelty that characterize the present disclosure, are pointed out with particularity in the claims annexed hereto and form a part of the present disclosure. For a better understanding of the present disclosure, its operating advantages, and the specific objects attained by its uses, reference should be made to the accompanying drawing and detailed description in which there are illustrated and described exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 shows a perspective view of a fastener driving apparatus, in accordance with an exemplary embodiment of the present disclosure;

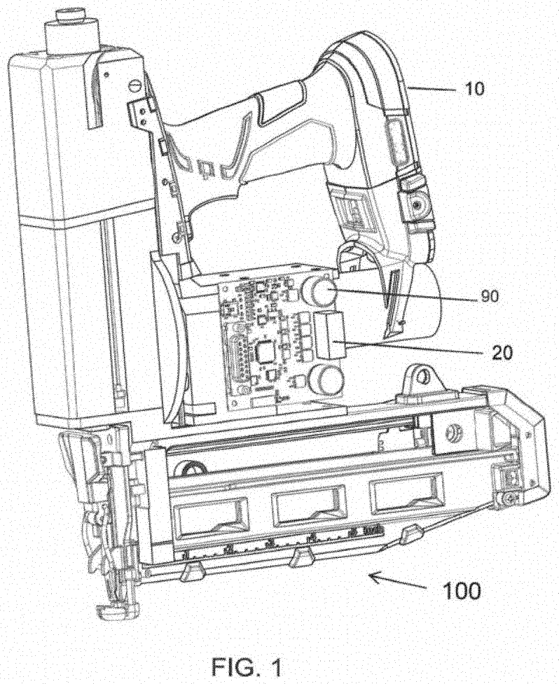

FIG. 2 shows another perspective view of a fastener driving apparatus, in accordance with an exemplary embodiment of the present disclosure; and

FIG. 3 shows a linear coil motor, piston, and anvil of a fastener driving apparatus, in accordance with an exemplary embodiment of the present disclosure.

### DETAILED DESCRIPTION OF THE DISCLOSURE

The best mode for carrying out the present disclosure is presented in terms of its preferred embodiment, herein depicted in the accompanying figure(s). The preferred embodiments described herein detail for illustrative purposes are subject to many variations. It is understood that various omissions and substitutions of equivalents are contemplated as circumstances may suggest or render expedient, but are intended to cover the application or implementation without departing from the spirit or scope of the present disclosure. Furthermore, although the following relates substantially to one embodiment of the design, it will be understood by those familiar with the art that changes to materials, part descriptions and geometries can be made without departing from the spirit of the disclosure. It is further understood that references such as front, back or top dead center, bottom dead center do not refer to exact positions but approximate positions as understood in the context of the geometry in the attached figures.

The terms “a” and “an” herein do not denote a limitation of quantity, but rather denote the presence of at least one of the referenced items.

Referring also to the figures, the present disclosure provides for a fastener driving apparatus 100. In an embodiment, the apparatus comprises a power source 10, a control circuit 20, a motor 30 (such as a linear motor or a coil motor), at least one energy storage device (such as a spring 40), a drive mechanism 50, a piston 42 and an anvil 60. The apparatus may further comprise at least one bumper 70. In an embodiment, the spring comprises a gas spring, which gas spring includes a gas spring cylinder 41 and a gas spring piston 42, which gas spring piston is at least partially disposed within a scaled chamber, and which gas spring piston is selectively actuated by the motor and/or drive mechanism.

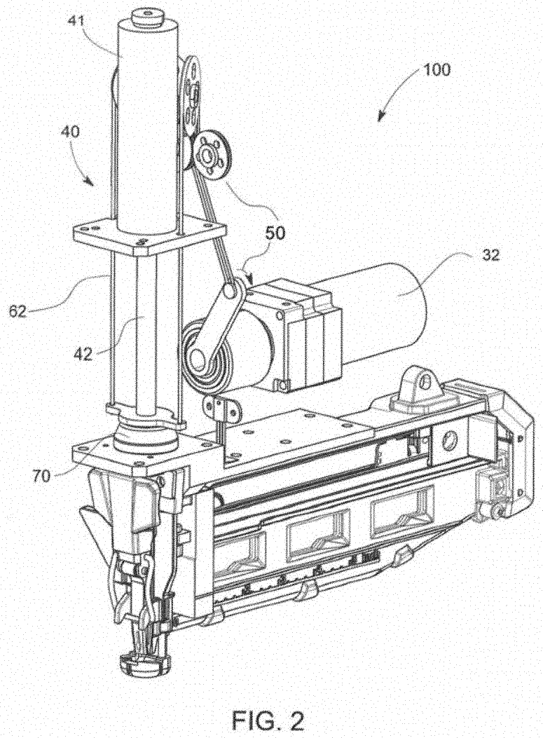

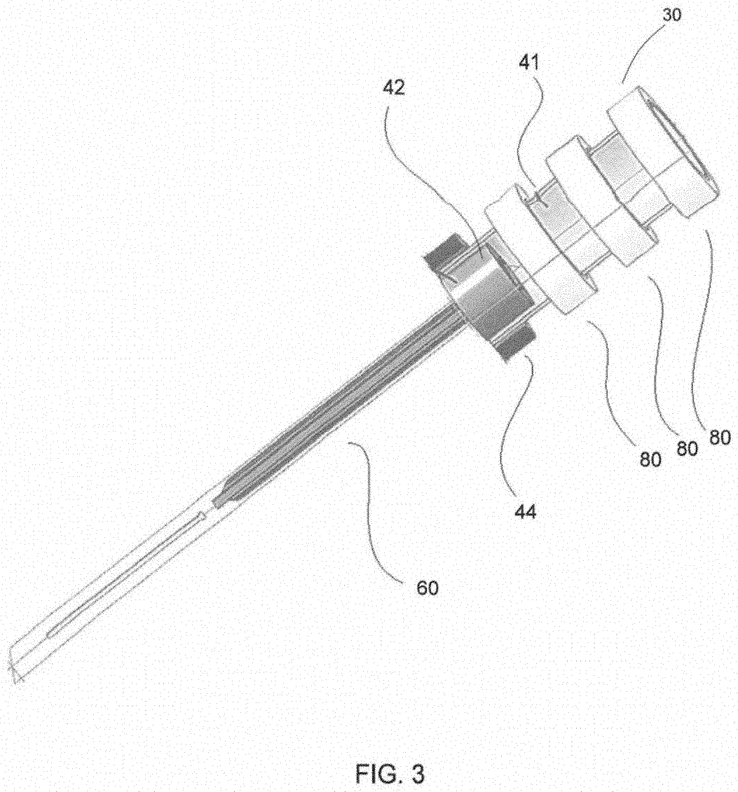

In an embodiment, and referring to FIG. 2 and FIG. 3, the linear motor 30 comprises a magnetic housing 32 and a coil 80. It will be apparent that the linear motor includes terminals for receipt of a voltage. When a voltage is applied across the terminals of the motor, the motor 30 is caused to move to one direction. Reversing the polarity of the applied voltage will move the motor to the opposite direction.

It will be apparent that the motor 30 and/or drive mechanism 50 is configured to energize the spring 40 and to thereafter release the gas spring 40 to drive a fastener. The motor 30/drive mechanism 50 is operatively coupled to the anvil 60 or piston 42, or, in a particular embodiment, coupled to the piston 42 such that the drive mechanism 50 may alternate in actuating the piston 42 and in refraining from applying a drive force on the piston 42. In a preferred embodiment, the linear motor 30 preferably acts directly upon the piston 42 (and in an embodiment, on a magnet 44 of the piston 42) to move the piston 42 to store potential energy (as described elsewhere herein.)

In an embodiment, the drive mechanism 50 and/or motor 30 engages and actuates the piston 42 to store potential energy within the gas spring 40, which actuation of the piston 42 may be referred to as an “energized position” of the piston.

In exemplary embodiment of an operational cycle, the drive mechanism 50/motor 30 thereafter disengages the piston 42, allowing potential energy to act on the piston 42 and cause the piston 42 to move and act on the anvil 60. In a still further embodiment, the linear motor 30 reverses direction and adds energy to assist in driving the anvil 60 and the fastener. The drive mechanism 50/motor 30 may thereafter again act on the piston 42 to again store potential energy within the gas spring 40 and may thereafter again temporarily cease to act on the piston to allow potential energy to instead act on the piston 42.

The anvil 60 may be operatively coupled to a guide 62, shaft, or other structure that limits and guides the range of motion of the anvil 50. To counteract drive mechanism loads on the anvil, bearings (and preferably, roller bearings) may be provided in the guide 62, shaft, or other structure that limits the range of motion.

A sensor 90 may be provided for determining at least one position of the spring or gas spring, drive mechanism, anvil and/or piston. The sensor may enable the proper timing for stopping the operational cycle of the apparatus. Further, this information can be used to detect a jam condition for proper recovery.

At least one bumper 70 may optionally be disposed on the apparatus for absorbing a portion of the force of impact of the anvil and/or piston, to reduce wear and tear on the components of the apparatus. The at least one bumper may be of an elastic material, for example, and may be disposed on the apparatus at any position where it is capable of absorbing a portion of the force of impact by the piston or the anvil.

The present disclosure offers the following advantages: the linear motor, gas springs, mechanical springs and elastomers are capable of generating s relatively high amount of force in a small amount of space such that the size of the apparatus may be smaller than other fastener drivers. Further, because of the relatively small increase from the initial pressure in the gas spring to the maximum pressure, the motor of the apparatus is not significantly overworked or over torqued, thus leading to a longer useful life of the apparatus.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the disclosure and various embodiments with various modifications as are suited to the particular use contemplated.

What is claimed is:

1. A fastener driving apparatus, the apparatus comprising:
a linear motor,
a power source,
a control circuit,
an energy storage device,
a drive mechanism,
a piston, and
an anvil, wherein said piston is operatively coupled to said anvil,
wherein at least one of the motor and drive mechanism are operatively coupled to at least one of the energy storage device and the piston such that at least one of the motor and drive mechanism may, for one portion of the operational cycle of the apparatus, actuate the piston and/or engage the energy storage device, and for another portion of the operational cycle of the apparatus, refrain from actuating the piston and/or engaging the energy storage device so as to selectively store potential energy in the energy storage device during the portion of the operational cycle in which at least one of the motor and drive mechanism actuate the piston and/or engage the energy storage device, and to allow the piston to move and act on the anvil to cause the anvil to act on a fastener.

2. The apparatus of claim 1, wherein said linear motor is also capable of engaging the piston when the piston is moving and acting on the anvil, through which engagement the motor may assist the piston with such moving and acting on the anvil.

3. The apparatus of claim 1, wherein said anvil is operatively coupled to a structure that limits and guides the range of motion of the anvil.

4. The apparatus of claim 1, wherein said linear motor comprises a magnet and a coil, and said piston comprises a magnet for operative coupling with said motor.

5. The apparatus of claim 1, said apparatus further comprising at least one sensor for determining the position of at least one of said energy storage device, drive mechanism, piston, and anvil.

6. The apparatus of claim 1, said apparatus further comprising at least one bumper for absorbing a portion of the force of impact of at least one of the anvil and piston.

7. The apparatus of claim 1, wherein said energy storage device comprises one of a spring and a gas spring, wherein said gas spring comprises a piston.

8. A fastener driving apparatus, the apparatus comprising:
a linear motor, said linear motor comprising a magnetic housing and at least one magnet,
a power source,
a control circuit,
an energy storage device,
a drive mechanism,
a piston, and
an anvil, wherein said piston is operatively coupled to said anvil,
wherein at least one of the motor and drive mechanism are operatively coupled to at least one of the energy storage device and the piston such that at least one of the motor and drive mechanism may, for one portion of the operational cycle of the apparatus, actuate the piston and/or engage the energy storage device, and for another portion of the operational cycle of the apparatus, refrain from actuating the piston and/or engaging the energy storage device so as to selectively store potential energy in the energy storage device during the portion of the operational cycle in which at least one of the motor and drive mechanism actuate the piston and/or engage the energy storage device, and to allow the piston to move and act on the anvil to cause the anvil to act on a fastener.

9. The apparatus of claim 8, wherein said linear motor is also capable of engaging the piston when the piston is moving and acting on the anvil, through which engagement the motor may assist the piston with such moving and acting on the anvil.

10. The apparatus of claim 8, wherein said anvil is operatively coupled to a structure that limits and guides the range of motion of the anvil.

11. The apparatus of claim 8, wherein said linear motor comprises a magnet and a coil, and said piston comprises a magnet for operative coupling with said motor.

12. The apparatus of claim 8, said apparatus further comprising at least one sensor for determining the position of at least one of said energy storage device, drive mechanism, piston, and anvil.

13. The apparatus of claim 8, said apparatus further comprising at least one bumper for absorbing a portion of the force of impact of at least one of the anvil and piston.

14. The apparatus of claim 8, wherein said energy storage device comprises one of a spring and a gas spring, wherein said gas spring comprises a piston.
